(19) United States
(12) Patent Application Publication
(10) Pub. No.: US 2026/0322950 A1
(43) Pub. Date: Oct. 15, 2026

(54) COMMUNICATION CONTROL DEVICE, COMMUNICATION CONTROL METHOD, STORAGE MEDIUM, AND COMMUNICATION CONTROL SYSTEM

(71) Applicant: HONDA MOTOR CO., LTD., Tokyo (JP)

(72) Inventors: Kenta Maruyama, Tokyo (JP); Yuta Nishizawa, Tokyo (JP); Yusuke Ishida, Tokyo (JP)

(21) Appl. No.: 19/467,088

(22) Filed: Feb. 2, 2026

(30) Foreign Application Priority Data
Mar. 28, 2025 (JP) 2025-056383

(51) Int. Cl. H04N 7/18; H04N 23/60; H04N 23/62; H04N 23/90

(52) U.S. Cl. CPC H04N 7/181; H04N 23/62; H04N 23/64; H04N 23/90

(57) ABSTRACT

A communication control device is a communication control device that transmits, via a server device, images shot by a plurality of cameras mounted in a vehicle to a display device configured to be able to display the images, and includes: a reception unit that receives, from an occupant of the vehicle, a first input operation that is an operation of inputting the number of the cameras to be used for shooting; and a proposal unit that proposes at least one of a shooting range and a shooting angle for each of the cameras, in response to the first input operation.

### INCORPORATION BY REFERENCE

The present application claims priority under 35 U.S.C. § 119 to Japanese Patent Application No. 2025-056383 filed on Mar. 28, 2025. The content of the application is incorporated herein by reference in its entirety.

### BACKGROUND OF THE INVENTION

### Field of the Invention

The present invention relates to a communication control device, a communication control method, a storage medium, and a communication control system.

### Description of the Related Art

In recent years, initiatives have become more active to provide access to sustainable transport systems that also consider people in vulnerable situations, such as older persons, persons with disabilities, and children, among traffic participants. To this end, efforts are focused on research and development to further improve traffic safety and convenience through developments related to conveyances specialized for vulnerable road users.

Japanese Patent Laid-Open No. 2024-39763 discloses an information processing system in which images are transmitted to VR goggles from a camera unit and a communication device that are mounted in a vehicle.

When a plurality of cameras is used for shooting and shot images are transmitted, the cameras need to be set, with the shooting range or the shooting angle of each of the cameras taken into consideration. Accordingly, there is a problem that the work of setting the cameras in a vehicle takes a lot of time and effort, in some cases.

The present invention has been made in view of such a circumstance, and an objective thereof is to improve work efficiency in the work of setting a plurality of cameras in a vehicle. A service that connects remote locations and a vehicle will, in turn, contribute to support for positive links between urban areas and peri-urban as well as rural areas, and also to the development of sustainable transport systems.

### SUMMARY OF THE INVENTION

A first aspect to achieve the objective is a communication control device that transmits, via a server device, images shot by a plurality of cameras mounted in a vehicle to a display device configured to be able to display the images. The communication control device includes: a reception unit that receives, from an occupant of the vehicle, a first input operation that is an operation of inputting the number of the cameras to be used for shooting; and a proposal unit that proposes at least one of a shooting range and a shooting angle for each of the cameras, in response to the first input operation.

A second aspect to achieve the objective is a communication control method performed by a communication control device that transmits, via a server device, images shot by a plurality of cameras mounted in a vehicle to a display device configured to be able to display the images. The communication control method includes: a reception step of receiving, from an occupant of the vehicle, an operation of inputting the number of the cameras to be used for shooting; and a proposal step of proposing at least one of a shooting range and a shooting angle for each of the cameras, in response to the number of the cameras.

A third aspect to achieve the objective is a non-transitory computer readable storage medium storing a control program causing a processor included in a communication control device that transmits, via a server device, images shot by a plurality of cameras mounted in a vehicle to a display device configured to be able to display the images, to function as: a reception unit that receives, from an occupant of the vehicle, an operation of inputting the number of the cameras to be used for shooting; and a proposal unit that proposes at least one of a shooting range and a shooting angle for each of the cameras, in response to the number of the cameras.

A fourth aspect to achieve the objective is a communication control system including: a plurality of cameras mounted in a vehicle; a communication control device that controls the cameras; and a server device that receives images shot by the cameras from the communication control device and transmits the images to a display device configured to able to display the image. The communication control device includes: a reception unit that receives, from an occupant of the vehicle, an operation of inputting the number of the cameras to be used for shooting; and a proposal unit that proposes at least one of a shooting range and a shooting angle for each of the cameras, in response to the number of the cameras.

The communication control device, the communication control method, the storage medium, and the communication control system make it possible to improve work efficiency in the work of setting a plurality of cameras in a vehicle.

### BRIEF DESCRIPTION OF THE DRAWINGS

FIG. 1 shows an example of a configuration of a communication control system according to an embodiment;

FIG. 2 shows an example of a configuration of a communication control device according to the present embodiment;

FIG. 3 is a plan view showing an example of the shooting ranges and the shooting angles of cameras;

FIG. 4 shows an example of a first setting position and a first reference image;

FIG. 5 shows an example of a second setting position and a second reference image;

FIG. 6 is a diagram of a screen showing an example of a to-be-displayed image selection part displayed on a display device;

FIG. 7 shows an example of a VR mode display part displayed on a display device; and

FIG. 8 is a flowchart showing an example of processing by the communication control device.

### DETAILED DESCRIPTION OF THE INVENTION

Hereinafter, embodiments of the present invention are described with reference to the drawings.

### Embodiment 1

### [1. Configuration of Communication System]

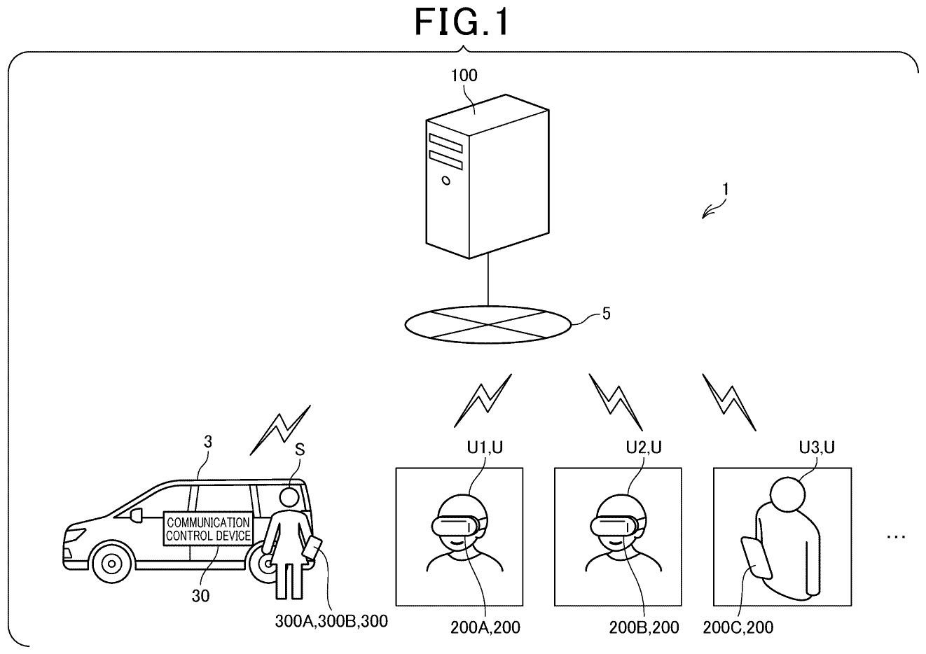

First, a configuration of a communication control system 1 according to the present embodiment is described with reference to FIG. 1. FIG. 1 shows an example of the configuration of the communication control system 1 according to the present embodiment.

As shown in FIG. 1, the communication control system 1 includes a communication control device 30, display devices 200, and a server device 100 (computer). The communication control system 1 is a system that transmits images PT shot by a camera CM included in a smartphone 300 to the display devices 200.

The communication control device 30 and the server device 100 are communicably connected to each other through a network 5. The server device 100 and each display device 200 are communicably connected to each other through the network 5.

The network 5 is, for example, the Internet. The network 5 may be, for example, a public network, such as a mobile communication network or a satellite communication network, a local area network (LAN), a wide area network (WAN), or the like.

The communication control device 30 transmits, through the server device 100, images PT shot by cameras CM included in a plurality of smartphones 300 on board a vehicle 3 to the display devices 200 configured to be able to display the images PT. The communication control device 30 is mounted in the vehicle 3, and communicates with each smartphone 300 used by a sender S that is an occupant of the vehicle 3, through, for example, short-range wireless communication, such as Bluetooth(R). The images PT are, for example, moving images.

The communication control device 30 receives, from the smartphones 300, the images PT shot by the cameras CM respectively included in the smartphones 300. The communication control device 30 uploads the images PT received from the smartphones 300 to the server device 100.

Although the present embodiment describes a case where the communication control device 30 uploads the images PT shot by the cameras CM included in the smartphones 300 to the server device 100, embodiments are not limited thereto. The communication control device 30 may upload the images PT shot by the cameras CM included in the smartphones 300, and sounds inputted into undepicted microphones, to the server device 100.

The server device 100 receives, from the communication control device 30, the images PT shot by the cameras CM respectively included in the smartphones 300. The server device 100 transmits, to the display devices 200 of users U, the images PT shot by the cameras CM respectively included in the smartphones 300.

Each smartphone 300 includes the camera CM and shoots images PT in accordance with an instruction from the communication control device 30. Each smartphone 300 transmits the shot images PT to the communication control device 30 in accordance with an instruction from the communication control device 30.

The smartphones 300 include a first smartphone 300A and a second smartphone 300B.

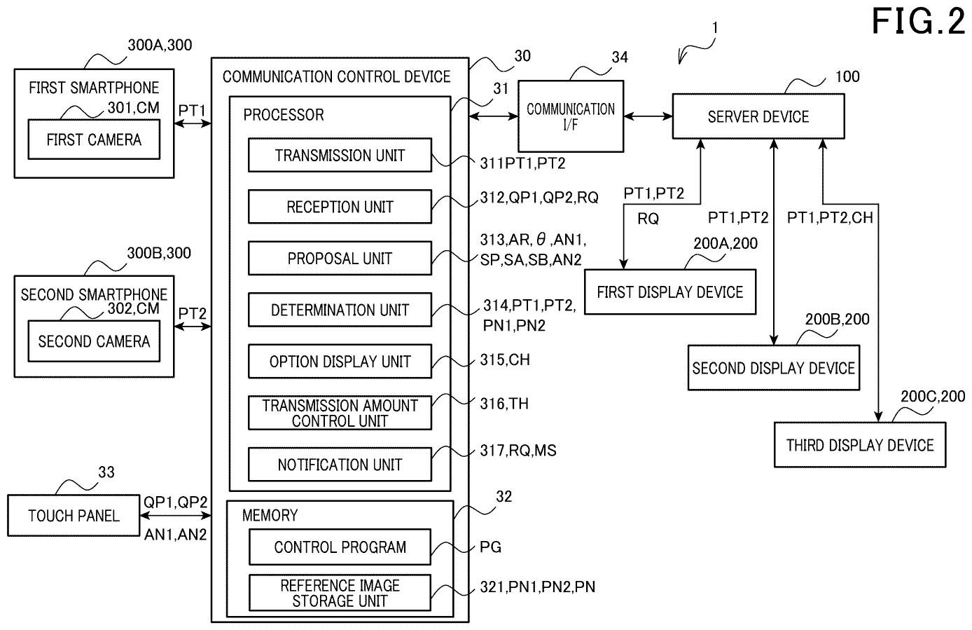

The cameras CM included in the smartphones 300 will be further described with reference to FIG. 2.

Each display device 200 is a display device carried by a user U that views images PT transmitted from the server device 100. As the users U, FIG. 1 shows three users U, which are users U1, U2, U3. The number of users U may be, for example, three, or may be, for example, 10 or more. Each display device 200 downloads images PT from the server device 100 and displays the images PT in a manner viewable by the user U.

For example, each display device 200 may be a mobile or portable display device, such as a smartphone, a tablet computer, or a notebook computer, or may be a stationary display device, such as a desktop computer. Each display devices 200 may be a television receiver, or may be a head-mounted display device, which has an image display unit that is mounted on the head of the user U so that a display included in the image display unit is positioned in front of the eyes of the user U. The head-mounted display device may be of any type as long as images PT transmitted from the server device 100 can be displayed, and may be a see-through or non-see-through head-mounted display device.

As the display devices 200, FIG. 1 illustrates a first display device 200A used by the user U1, a second display device 200B used by the user U2, and a third display device 200C used by the user U3. The first display device 200A and the second display device 200B are, for example, head-mounted display devices. The third display device 200C is, for example, a tablet computer.

### [2. Configuration of Communication Control Device]

Next, a configuration of the communication control device 30 is described with reference to FIG. 2. FIG. 2 shows an example of the configuration of the communication control device 30.

The communication control device 30 is configured by using, for example, an electronic control unit (ECU). The communication control device 30 includes a touch panel 33 and a communication interface 34. In FIG. 2, the communication interface is abbreviated as “communication I/F”.

The touch panel 33 includes a display panel, such as a liquid crystal panel or an organic electro-luminescence (EL) panel, and a touch sensor. The touch sensor is disposed integrally with a display face of the display panel. The touch sensor detects an operation of touching by the sender S and outputs a signal indicating the detected operation of touching to the communication control device 30.

The touch panel 33 is disposed on, for example, a dashboard of the vehicle 3.

The communication interface 34 includes an antenna, a connector, and interface circuitry, and is connected to a processor 31. The communication interface 34 is an interface for communicating with the server device 100. For example, the communication interface 34 is an interface that wirelessly communicates with the server device 100 in conformity with the 4G standard, the 5G standard, or the Wi-Fi® standard.

The communication interface 34 wirelessly communicates with the server device 100 via an undepicted wireless base station and the Internet.

The communication control device 30 is configured to be able to communicate with the first smartphone 300A and the second smartphone 300B. The communication control device 30 communicates with the first smartphone 300A and the second smartphone 300B through short-range wireless communication, such as Bluetooth®. The first smartphone 300A and the second smartphone 300B correspond to an example of the smartphones 300. The communication control device 30 is mounted in the vehicle 3.

The first smartphone 300A includes a first camera 301. The first camera 301 includes an image sensor, such as a charge coupled device (CCD) or a complementary metal oxide semiconductor (CMOS). The first camera 301 picks up first images PT1 and outputs the picked-up first images PT1 to the communication control device 30 in accordance with an instruction from the communication control device 30. The first camera 301 corresponds to an example of the camera CM. The first images PT1 corresponds to an example of the images PT.

The second smartphone 300B includes a second camera 302. The second camera 302 includes an image sensor, such as a CCD or a CMOS. The second camera 302 picks up second images PT2 and outputs the picked-up second images PT2 to the communication control device 30 in accordance with an instruction from the communication control device 30. The second camera 302 corresponds to an example of the camera CM. The second images PT2 corresponds to an example of the images PT.

The communication control device 30 includes the processor 31 and a memory 32.

The processor 31 is configured by using a central processing unit (CPU) or a microprocessor unit (MPU). The processor 31 may be configured by using a single processor, or also can be configured by using a plurality of processors. The memory 32 is configured by using, for example, a non-volatile semiconductor memory, or volatile and non-volatile semiconductor memories. The memory 32 stores a control program PG.

The communication control device 30 includes a transmission unit 311, a reception unit 312, a proposal unit 313, a determination unit 314, an option display unit 315, a transmission amount control unit 316, a notification unit 317, and a reference image storage unit 321. The processor 31 functions as the transmission unit 311, the reception unit 312, the proposal unit 313, the determination unit 314, the option display unit 315, and the transmission amount control unit 316, by reading from the memory 32 and executing the control program PG. The processor 31 causes the memory 32 to function as the reference image storage unit 321, by reading from the memory 32 and executing the control program PG.

The reference image storage unit 321 stores a plurality of reference images PN beforehand. The reference image storage unit 321 stores each of the reference images PN in association with a shooting range AR and a shooting angle θ beforehand.

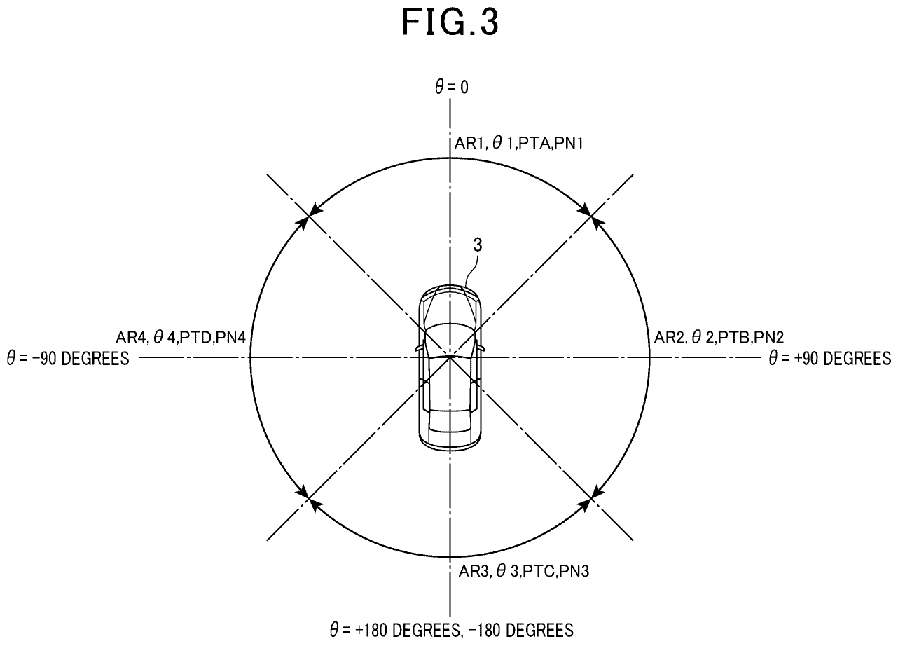

Here, the shooting ranges AR and the shooting angles θ of the cameras CM are described with reference to FIG. 3. FIG. 3 is a plan view showing an example of the shooting ranges AR and the shooting angles θ of the cameras. The shooting ranges AR include, for example, a first shooting range AR1 to a fourth shooting range AR4. The shooting angles θ include, for example, a first shooting angle θ1 to a fourth shooting angle θ4.

As shown in FIG. 3, the first shooting range AR1 corresponds to a front image PTA that is a shot image of a view in front of the vehicle 3. The second shooting range AR2 corresponds to a right image PTB that is a shot image of a view to the right of the vehicle 3. The second shooting range AR2 includes an image of the driver and is therefore referred to as a driver image PTB in some cases. The third shooting range AR3 corresponds to a rear image PTC that is a shot image of a view behind the vehicle 3. The fourth shooting range AR4 corresponds to a left image PTD that is a shot image of a view to the left of the vehicle 3.

The shooting angles θ are, for example, angles with respect to a direction forward of the vehicle 3 in a horizontal plane included in the shooting ranges AR, assuming that the direction forward of the vehicle 3 is “zero degrees”. For example, the shooting angles θ range from “−180 degrees” to “+180 degrees”.

A shooting angle θ of “−90 degrees” indicates a direction to the left of the vehicle 3. A shooting angle θ of “+90 degrees” indicates a direction to the right of the vehicle 3. A shooting angle θ of “−180 degrees” or “+180 degrees” indicates a direction rearward of the vehicle 3.

The first shooting angle θ1 corresponds to, for example, any shooting angle θ between “−45 degrees” and “+45 degrees” inclusive. The first shooting angle θ1 corresponds to the first shooting range AR1. The second shooting angle θ2 corresponds to, for example, any shooting angle θ between “+45 degrees” and “+135 degrees” inclusive. The second shooting angle θ2 corresponds to the second shooting range AR2. The third shooting angle θ3 corresponds to, for example, any shooting angle θ between “+135 degrees” and “+180 degrees” inclusive and between “−180 degrees” and “−135 degrees” inclusive. The third shooting angle θ3 corresponds to the third shooting range AR3. The fourth shooting angle θ4 corresponds to, for example, any shooting angle θ between “−135 degrees” and “−45 degrees” inclusive. The fourth shooting angle θ4 corresponds to the fourth shooting range AR4.

Referring back to FIG. 2, the configuration of the communication control device 30 is described again.

The reference image storage unit 321 stores, for example, a first reference image PN1 to a fourth reference image PN4 beforehand. The first reference image PN1 is a reference image PN when a view in the direction forward of the vehicle 3 is shot. The first reference image PN1 is stored in association with the first shooting range AR1 and the first shooting angle θ1. The second reference image PN2 is a reference image PN when a view in the direction to the right of the vehicle 3 is shot. The second reference image PN2 is stored in association with the second shooting range AR2 and the second shooting angle θ2. The third reference image PN3 is a reference image PN when a view in the direction rearward of the vehicle 3 is shot. The third reference image PN3 is stored in association with the third shooting range AR3 and the third shooting angle θ3. The fourth reference image PN4 is a reference image PN when a view in the direction to the left of the vehicle 3 is shot. The fourth reference image PN4 is stored in association with the fourth shooting range AR4 and the fourth shooting angle θ4.

Although the present embodiment describes a case where the angle of view of the cameras CM is 90 degrees, embodiments are not limited thereto. The angle of view of the cameras CM may be, for example, 60 degrees. The angle of view of the cameras CM may be, for example, 120 degrees.

The transmission unit 311 transmits, via the server device 100, images PT shot by the cameras CM mounted in the vehicle 3 to the display devices 200 configured to be able to display the images PT.

For example, the transmission unit 311 acquires first images PT1 shot by the first camera 301 of the first smartphone 300A and second images PT2 shot by the second camera 302 of the second smartphone 300B. Then, the transmission unit 311 transmits the first images PT1 and the second images PT2 to the display devices 200 via the server device 100. The display devices 200 include the first display device 200A, the second display device 200B, and the third display device 200C.

The reception unit 312 receives, from the sender S, a first input operation QP1 that is an operation of inputting the number NC of the cameras CM to be used for shooting. The number NC of the cameras CM is, for example, two.

For example, the sender S performs the first input operation QP1 on the touch panel 33. The touch panel 33 receives the first input operation QP1 and outputs information indicating the first input operation QP1 to the processor 31. The reception unit 312 receives the information indicating the first input operation QP1 from the touch panel 33.

The sender S corresponds to an example of “an occupant of the vehicle”.

The reception unit 312 receives, from the sender S, a second input operation QP2 that is an operation of inputting at least one of the shooting range AR and the shooting angle θ of each of the cameras CM.

For example, the sender S performs the second input operation QP2 on the touch panel 33. The touch panel 33 receives the second input operation QP2 and outputs information indicating the second input operation QP2 to the processor 31. The reception unit 312 receives the information indicating the second input operation QP2 from the touch panel 33.

The proposal unit 313 proposes, to the touch panel 33, at least one of a shooting range AR and a shooting angle θ for each of the cameras CM, in response to the first input operation QP1. The cameras CM include, for example, the first camera 301 of the first smartphone 300A and the second camera 302 of the second smartphone 300B.

For example, the proposal unit 313 proposes, as a first response AN1, the first shooting range AR1 and the first shooting angle θ1 for the first camera 301, and the second shooting range AR2 and the second shooting angle θ2 for the second camera 302. The first response AN1 is a response to the first input operation QP1.

The first shooting range AR1 indicates front images PTA that are shot images of a view in front of the vehicle 3. When the first shooting range AR1 is proposed for the first camera 301, the touch panel 33 displays, for example, a message: “Please shoot a view in front of the vehicle with the first camera.”

The first shooting angle θ1 indicates, for example, a shooting angle θ between “−45 degrees” and “+45 degrees” inclusive. When the first shooting angle θ1 is proposed for the first camera 301, the touch panel 33 displays, for example, a message: “Please perform shooting with the first camera at a shooting angle between −45 degrees and +45 degrees inclusive.”

The second shooting range AR2 indicates right images PTB that are shot images of a view to the right of the vehicle 3. When the second shooting range AR2 is proposed for the second camera 302, the touch panel 33 displays, for example, a message: “Please shoot a view to the right of the vehicle with the second camera.”

The second shooting angle θ2 indicates, for example, a shooting angle θ between “+45 degrees” and “+135 degrees” inclusive. When the second shooting angle θ2 is proposed for the second camera 302, the touch panel 33 displays, for example, a message: “Please perform shooting with the second camera at a shooting angle between +45 degrees and +135 degrees inclusive.”

Note that when the touch panel 33 displays the messages about the first shooting range AR1 and the second shooting range AR2, it is preferable to display an image defining the shooting ranges AR, like the image shown in FIG. 3. By displaying the image defining the shooting ranges AR, the sender S can easily understand the first shooting range AR1 and the second shooting range AR2.

When the touch panel 33 displays the messages about the first shooting angle θ1 and the second shooting angle θ2, it is preferable to display an image defining the shooting angles θ, like the image shown in FIG. 3. By displaying the image defining the shooting angles θ, the sender S can easily understand the first shooting angle θ1 and the second shooting angle θ2.

The proposal unit 313 proposes a setting position SP of each of the cameras CM, in response to the second input operation QP2. For example, the proposal unit 313 proposes, as a second response AN2, a first setting position SA that is a setting position SP of the first camera 301, and a second setting position SB that is a setting position SP of the second camera 302. The second response AN2 is a response to the second input operation QP2.

The setting positions SP include respective orientations of the first camera 301 and the second camera 302.

The first camera 301 and the second camera 302 correspond to an example of “a plurality of cameras” or “the cameras”.

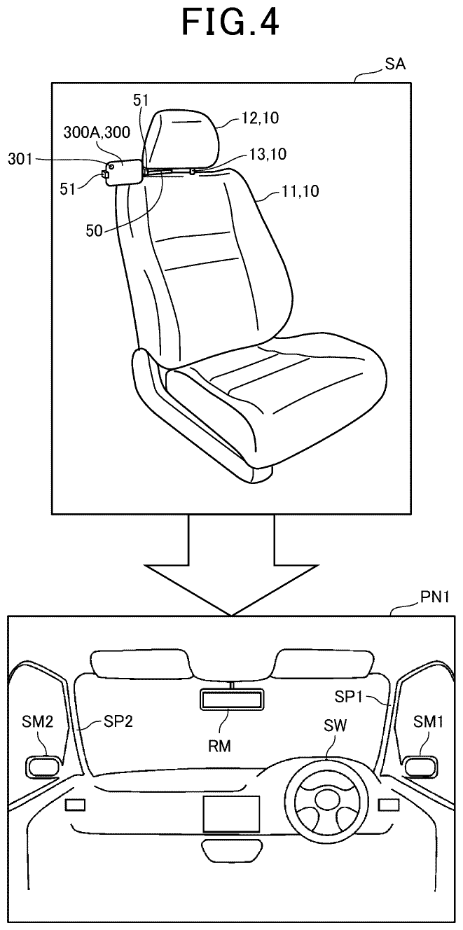

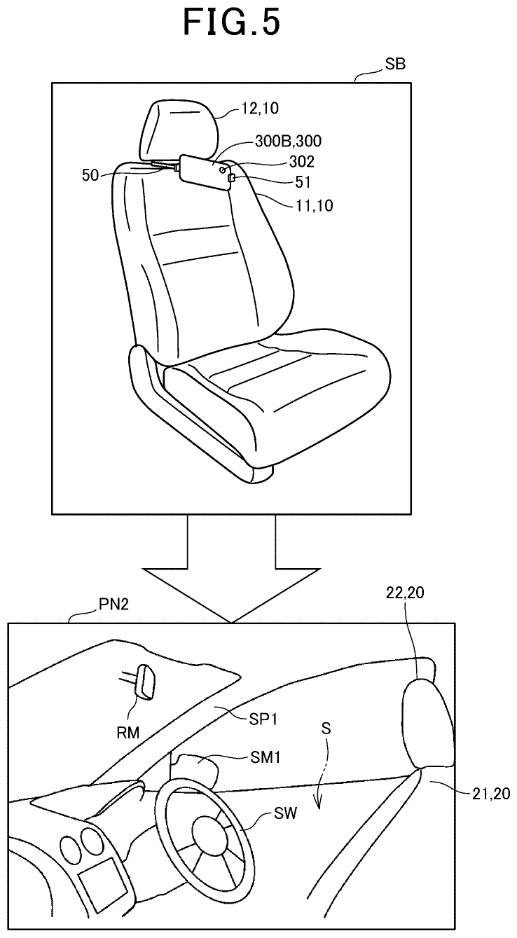

The first setting position SA and the second setting position SB will be further described with reference to FIGS. 4 and 5.

The determination unit 314 determines, based on images shot by each of the cameras CM, whether each of the cameras CM is set at the setting position SP thereof.

For example, the determination unit 314 determines whether the first camera 301 is set at the first setting position SA, by comparing the first images PT1 that are images shot by the first camera 301 with the first reference image PN1 corresponding to the first setting position SA. The first reference image PN1 is a reference image PN stored in the reference image storage unit 321 in association with the first shooting range AR1 and the first shooting angle θ1 that correspond to the first setting position SA.

The first setting position SA and the first reference image PN1 will be further described with reference to FIG. 4.

For example, the determination unit 314 determines whether the second camera 302 is set at the second setting position SB, by comparing the second images PT2 that are images shot by the second camera 302 with the second reference image PN2 corresponding to the second setting position SB. The second reference image PN2 is a reference image PN stored in the reference image storage unit 321 in association with the second shooting range AR2 and the second shooting angle θ2 that correspond to the second setting position SB.

The second setting position SB and the second reference image PN2 will be further described with reference to FIG. 5.

The option display unit 315 causes a display device 200 to display options of images for the display device 200 to display, according to the number NC of the cameras CM.

The option display unit 315 causes, via the server device 100, the display device 200 to display options of images for the display device 200 to display, according to the number NC of the cameras MC. In other words, the option display unit 315 causes the server device 100 to make options of images for the display device 200 to display displayed, according to the number NC of the cameras CM. The display device 200 displays the options of images in a to-be-displayed image selection part CH.

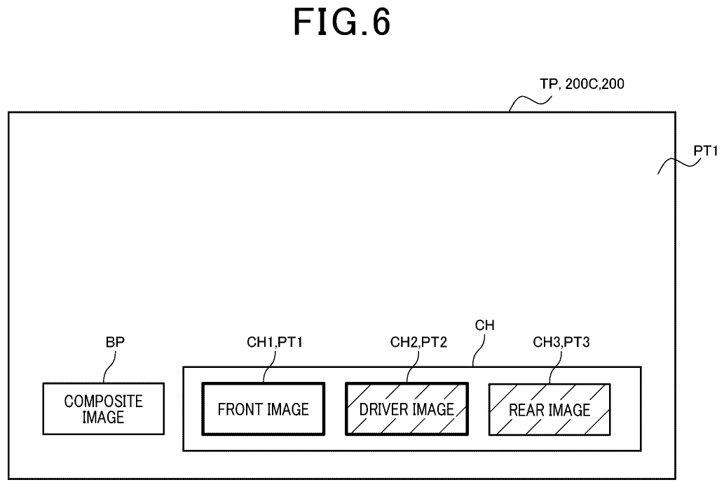

The to-be-displayed image selection part CH will be further described with reference to FIG. 6.

When a display device 200 continues to display only images PT shot by one of the cameras CM for a threshold time period TH or longer, the transmission amount control unit 316 causes the server device 100 to reduce the amount of transmission, or stop transmission, of images PT shot by the other of the cameras CM to the display device 200. The threshold time period TH is, for example, 10 minutes.

When the amount of transmission of images PT is to be reduced, for example, the images PT are transmitted as still images at predetermined time intervals. The predetermined time interval is, for example, five seconds.

For example, a case is described where the transmission unit 311 transmits first images PT1 and second images PT2 to the display devices 200. When the third display device 200C continues to display only the first images PT1 for the threshold time period TH or longer, for example, the transmission amount control unit 316 causes the server device 100 to stop transmission of the second images PT2, or reduce the amount of transmission thereof, to the third display device 200C.

Second images PT2 correspond to an example of “images PT shot by the other of the cameras CM”.

When a display device 200 continues to display only images PT shot by one of the cameras CM for the threshold time period TH or longer, the transmission amount control unit 316 may reduce the amount of transmission, or stop transmission, of images PT shot by the other of the cameras CM to the server device 100.

In such a case, for example, when the third display device 200C continues to display only the first images PT1 for the threshold time period TH or longer, the transmission amount control unit 316 stops transmission of the second images PT2, or reduces the amount of transmission thereof, to the server device 100.

When the notification unit 317 receives, from a display device 200, an operation RQ for requesting transmission of images PT shot by each of the cameras CM, the notification unit 317 notifies the content of the operation RQ to the sender S.

For example, the first display device 200A receives, from the user U1, an operation RQ for requesting transmission of images PT shot by each of the cameras CM. The first display device 200A transmits information indicating the operation RQ to the server device 100. When the server device 100 receives the information indicating the operation RQ, the server device 100 transmits the information indicating the operation RQ to the communication control device 30. The reception unit 312 receives the information indicating the operation RQ from the first display device 200A. The operation RQ is, for example, an operation for requesting transmission of rear images PTC that are shot images of a view behind the vehicle 3.

In such a case, the notification unit 317 displays, on the touch panel 33, the fact that the operation RQ for requesting transmission of rear images PTC is received from the first display device 200A. The touch panel 33 displays, for example, a message MS: “An operation for requesting transmission of rear images is received from the user of the first display device.”

When the operation RQ for requesting transmission of images PT shot by each of the cameras CM is received from a display device 200, the proposal unit 313 proposes at least one of a shooting range AR and a shooting angle θ for each of the cameras CM, according to the content of the operation RQ and the number NC of the cameras CM received by the reception unit 312.

In the following description, for example, a case is described where the plurality of cameras CM includes the first camera 301 and the second camera 302, the first camera 301 is picking up front images PTA, and the second camera 302 is picking up right images PTB.

For example, when the operation RQ is an operation for requesting transmission of front images PTA and rear images PTC, the proposal unit 313 proposes at least one of the third shooting range AR3 and the third shooting angle θ3 for the second camera 302. In other words, the proposal unit 313 proposes at least one of the third shooting range AR3 corresponding to rear images PTC and the third shooting angle θ3 corresponding to rear images PTC so that the second camera 302 will pick up rear images PTC.

For example, when the operation RQ is an operation for requesting transmission of front images PTA, rear images PTC, and right images PTB, the proposal unit 313 proposes at least one of the third shooting range AR3 and the third shooting angle θ3 for the second camera 302. In other words, the proposal unit 313 proposes at least one of the third shooting range AR3 corresponding to rear images PTC and the third shooting angle θ3 corresponding to rear images PTC so that the second camera 302 will pick up rear images PTC.

### [3. Examples of Setting Positions and Reference Images]

Next, an example of the first setting position SA and the first reference image PN1 is described with reference to FIG. 4. FIG. 4 shows an example of the first setting position SA and the first reference image PN1.

The first setting position SA shown in an upper half of FIG. 4 indicates a position where the first camera 301 of the first smartphone 300A is placed when picking up front images PTA that are shot images of a view in front of the vehicle 3.

As shown in the upper half of FIG. 4, the first smartphone 300A is attached to a headrest stay 13 of a passenger seat by using, for example, an attachment 50. The headrest stay 13 is formed with a headrest 12 of a seat 10 of the passenger seat as one unit, and fixes the headrest 12 to a seat back 11.

A first fastener 51 that fastens the first smartphone 300A to the attachment 50 is provided at one end of the attachment 50, and an undepicted second fastener that fastens the attachment 50 to the headrest stay 13 is provided at the other end of the attachment 50.

As shown in the upper half of FIG. 4, the first camera 301 of the first smartphone 300A is placed at the first setting position SA in such a manner as to pick up front images PTA that are shot images of a view in front of the vehicle 3.

The first reference image PN1 shown in a lower half of FIG. 4 is read from the reference image storage unit 321 when the determination unit 314 determines whether the first camera 301 of the first smartphone 300A is set at the first setting position SA.

The determination unit 314 determines whether the first camera 301 is set at the first setting position SA, by comparing a first image PT1 that is an image shot by the first camera 301 with the first reference image PN1. The first reference image PN1 is an image shot by the first camera 301 when the first camera 301 is set at the first setting position SA.

As shown in the lower half of FIG. 4, the first reference image PN1 includes respective images of a right side-view mirror SM1, a right-side A-pillar SP1, a steering wheel SW, a rear-view mirror RM, a left-side A-pillar SP2, and a left side-view mirror SM2.

For example, the determination unit 314 extracts feature images by performing image processing of each of the first image PT1 and the first reference image PN1. The feature images include, for example, respective images of the right-side A-pillar SP1, the left-side A-pillar SP2, and the rear-view mirror RM.

The determination unit 314 determines whether the first camera 301 is set at the first setting position SA, for example, based on whether the respective images of the right-side A-pillar SP1, the left-side A-pillar SP2, and the rear-view mirror RM in the first image PT1 coincide with the respective images of the right-side A-pillar SP1, the left-side A-pillar SP2, and the rear-view mirror RM in the first reference image PN1.

For example, the determination unit 314 evaluates a degree of coincidence between the image of the right-side A-pillar SP1 in the first image PT1 and the image of the right-side A-pillar SP1 in the first reference image PN1. For example, the determination unit 314 evaluates a degree of coincidence between the image of the left-side A-pillar SP2 in the first image PT1 and the image of the left-side A-pillar SP2 in the first reference image PN1. For example, the determination unit 314 evaluates a degree of coincidence between the image of the rear-view mirror RM in the first image PT1 and the image of the rear-view mirror RM in the first reference image PN1.

Then, the determination unit 314 determines whether the first camera 301 is set at the first setting position SA, based on the degree of coincidence between the images of the right-side A-pillar SP1, the degree of coincidence between the images of the left-side A-pillar SP2, and the degree of coincidence between the images of the rear-view mirror RM. For example, when the degree of coincidence between the images of the right-side A-pillar SP1, the degree of coincidence between the images of the left-side A-pillar SP2, and the degree of coincidence between the images of the rear-view mirror RM are a predetermined threshold value or more, the determination unit 314 determines that the first camera 301 is set at the first setting position SA. The predetermined threshold value is, for example, “90%”. Note that the degree of coincidence is evaluated, for example, based on the position, the size, and the like of an image of a member from which features are configured.

Next, an example of the second setting position SB and the second reference image PN2 are described with reference to FIG. 5. FIG. 5 shows an example of the second setting position SB and the second reference image PN2.

The second setting position SB shown in an upper half of the FIG. 5 indicates a position where the second camera 302 of the second smartphone 300B is placed when picking up right images PTB that are shot images of a view to the right of the vehicle 3.

As shown in the upper half of the FIG. 5, the second smartphone 300B is attached to the headrest stay 13 of the passenger seat by using the attachment 50.

The first fastener 51 that fastens the second smartphone 300B to the attachment 50 is provided at one end of the attachment 50, and the undepicted second fastener that fastens the attachment 50 to the headrest stay 13 is provided at the other end of the attachment 50.

As shown in the upper half of the FIG. 5, the second camera 302 of the second smartphone 300B is placed at the second setting position SB in such a manner as to pick up right images PTB that are shot images of a view to the right of the vehicle 3.

The second reference image PN2 shown in a lower half of FIG. 5 is read from the reference image storage unit 321 when the determination unit 314 determines whether the second camera 302 of the second smartphone 300B is set at the second setting position SB.

The determination unit 314 determines whether the second camera 302 is set at the second setting position SB, by comparing a second image PT2 that is an image shot by the second camera 302 with the second reference image PN2. The second reference image PN2 is an image shot by the second camera 302 when the second camera 302 is set at the second setting position SB.

As shown in the lower half of FIG. 5, the second reference image PN2 includes respective images of the right side-view mirror SM1, the right-side A-pillar SP1, the steering wheel SW, the rear-view mirror RM, a headrest 22, and a seat back 21. The headrest 22 and the seat back 21 are included in a seat 20 of a driver seat. Although the sender S is, for example, sitting in the seat 20 of the driver seat in the second reference image PN2, the depiction of an image of the sender S is omitted for convenience in the second reference image PN2 shown in the lower half of FIG. 5.

For example, the determination unit 314 extracts feature images by performing image processing of each of the second image PT2 and the second reference image PN2. The feature images include, for example, respective images of the right-side A-pillar SP1, the rear-view mirror RM, and the headrest 22.

The determination unit 314 determines whether the second camera 302 is set at the second setting position SB, for example, based on whether the respective images of the right-side A-pillar SP1, the rear-view mirror RM, and the headrest 22 in the second image PT2 coincide with the respective images of the right-side A-pillar SP1, the rear-view mirror RM, and the headrest 22 in the second reference image PN2.

For example, the determination unit 314 evaluates a degree of coincidence between the image of the right-side A-pillar SP1 in the second image PT2 and the image of the right-side A-pillar SP1 in the second reference image PN2. For example, the determination unit 314 evaluates a degree of coincidence between the image of the rear-view mirror RM in the second image PT2 and the image of the rear-view mirror RM in the second reference image PN2. For example, the determination unit 314 evaluates a degree of coincidence between the image of the headrest 22 in the second image PT2 and the image of the headrest 22 in the second reference image PN2.

Then, the determination unit 314 determines whether the second camera 302 is set at the second setting position SB, based on the degree of coincidence between the images of the right-side A-pillar SP1, the degree of coincidence between the images of the rear-view mirror RM, and the degree of coincidence between the images of the headrest 22. For example, when the degree of coincidence between the images of the right-side A-pillar SP1, the degree of coincidence between the images of the rear-view mirror RM, and the degree of coincidence between the images of the headrest 22 are a predetermined threshold value or more, the determination unit 314 determines that the second camera 302 is set at the second setting position SB. The predetermined threshold value is, for example, “90%”. Note that the degree of coincidence is evaluated, for example, based on the position, the size, and the like of an image of a member from which features are configured.

[4. Examples of To-be-displayed Image Selection Part]

Next, an example of the to-be-displayed image selection part CH displayed on a display device 200 is described with reference to FIG. 6. FIG. 6 is a diagram of a screen showing an example of the to-be-displayed image selection part CH displayed on the third display device 200C. The third display device 200C is a tablet computer. FIG. 6 shows an example of the to-be-displayed image selection part CH displayed on the touch panel TP provided to the tablet computer included in the third display device 200C.

As shown in FIG. 6, the to-be-displayed image selection part CH is displayed, for example, in a lower portion of the touch panel TP. The to-be-displayed image selection part CH includes a first option CH1, a second option CH2, and a third option CH3.

The first option CH1 is selected when first images PT1 are to be displayed on the touch panel TP. The user U3 performs an operation of touching the first option CH1 when selecting the first option CH1. Since, for example, the first option CH1 is selected in FIG. 6, first images PT1 will be displayed on the touch panel TP.

Moreover, in FIG. 6, for example, since the first option CH1 is selected, the first option CH1 is rendered as an outline rectangle, and the second option CH and the third option CH3 are hatched.

Note that first images PT1 correspond to an example of front images PTA. Accordingly, “front image” is written in the first option CH1.

The second option CH2 is selected when second images PT2 are to be displayed on the touch panel TP. The user U3 performs an operation of touching the second option CH2 when selecting the second option CH2. For example, the second option CH2 is not selected in FIG. 6. Accordingly, in FIG. 6, the second option CH2 is hatched.

Note that second images PT2 correspond to an example of driver images PTB. Accordingly, “driver image” is written in the second option CH2.

Moreover, since the third display device 200C is receiving first images PT1 and second images PT2, the first option CH1 and the second option CH2 are marked with thick lines. On the other hand, the third option CH3 is marked with a thin line because the third display device 200C is not receiving third images PT3.

The third option CH3 is selected when third images PT3 are to be displayed on the touch panel TP. The user U3 performs an operation of touching the third option CH3 when selecting the third option CH3. For example, the third option CH3 is not selected in FIG. 6. Accordingly, in FIG. 6, the third option CH3 is hatched.

Note that third images PT3 correspond to, for example, an example of rear images PTC. Accordingly, “rear image” is written in the third option CH3.

Although FIG. 6 describes a case where the to-be-displayed image selection part CH includes the first option CH1, the second option CH2, and the third option CH3, embodiments are not limited thereto. The to-be-displayed image selection part CH can include at least the first option CH1 and the second option CH2. For example, the to-be-displayed image selection part CH may be configured to include the first option CH1 and the second option CH2, omitting to include the third option CH3. For example, the to-be-displayed image selection part CH may include a fourth option in addition to the first option CH1, the second option CH2, and the third option CH3. The fourth option corresponds to, for example, left images PTD.

Moreover, in FIG. 6, a composite image button BP is displayed. The composite image button BP is selected when composite images PC are to be displayed on the touch panel TP. The composite images PC are, for example, images obtained by combining first images PT1 and second images PT2. The composite images PC are generated by the communication control device 30, for example, when the communication control device 30 receives first images PT1 from the first smartphone 300A and receives second images PT2 from the second smartphone 300B. The transmission unit 311 of the communication control device 30 transmits the composite images PC, similarly to the first images PT1 and the second images PT2, to the display device 200 via the server device 100. The communication control device 30 instructs the display device 200, via the server device 100, to display the composite image button BP.

The user U3 performs an operation of touching the composite image button BP when displaying composite images PC on the touch panel TP.

When composite images PC are displayed on the touch panel TP, the user U3 moves an image area displayed on the touch panel TP, of the composite images PC, for example, by performing an operation of swiping on the touch panel TP.

The user U3 moves the image area displayed on the touch panel TP, of the composite images PC, in a leftward direction, for example, by performing an operation of swiping to the right on the touch panel TP. The user U3 moves the image area displayed on the touch panel TP, of the composite images PC, in a rightward direction, for example, by performing an operation of swiping to the left on the touch panel TP.

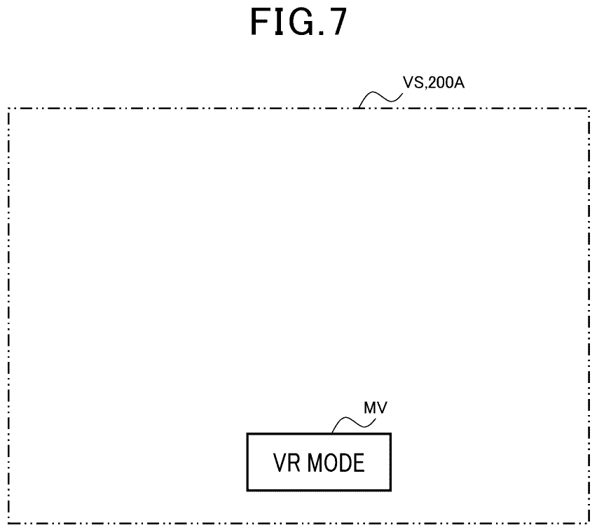

In FIG. 6, the case has been described where a display device 200 is the third display device 200C. With reference to FIG. 7, a case is described where a display device 200 is the first display device 200A or the second display device 200B. Each of the first display device 200A and the second display device 200B is a head-mounted display device. The head-mounted display device is, for example, “virtual reality (VR) goggles” as shown in FIG. 1.

Next, the case where each of the first display device 200A and the second display device 200B is “VR goggles” is described hereinafter, with reference to FIG. 7.

For example, composite images PC are displayed on each of the first display device 200A and the second display device 200B.

FIG. 7 shows an example of a VR mode display part MV displayed on the first display device 200A.

A field of view VS shown in FIG. 7 indicates the field of view of the user U1 wearing the first display device 200A. The VR mode display part MV is displayed in the field of view VS. For example, a character image, “VR mode”, is displayed in the VR mode display part MV. In the VR mode, the “VR goggles” that are the first display device 200A perform the following processing.

For example, when the user U1 is wearing the “VR goggles” as the first display device 200A, the first display device 200A displays composite images PC on the “VR goggles”.

In such a case, wider viewing angle images can be displayed by displaying composite images PC, compared to cases of displaying first images PT1 or second images PT2. Moreover, since wider viewing angle images are displayed on the “VR goggles”, the user U1 can gain a sense of presence or a sense of immersion.

Moreover, for example, when the user U1 is wearing the “VR goggles” as the first display device 200A, the first display device 200A moves the field of view VS of the user 1, that is, the scope of images visible to the user U1 (=the field of view VS), based on the movement of the head or the line of sight of the user U1. For example, when the user U1 is facing the front, the first display device 200A displays images corresponding to first images PT1, that is, front images PTA, included in the composite images PC. When the user U1 is facing right, the first display device 200A displays images corresponding to second images PT2, that is, right images PTB, included in the composite images PC.

As described above, by the “VR goggles” performing the VR mode, the scope of images visible to the user U1 (=the field of view VS) is moved based on the movement of the head or the line of sight of the user U1. Accordingly, the convenience of the user U1 can be improved, and the user U1 can gain a sense of presence and a sense of immersion.

Although the present embodiment has described a case where composite images PC are images obtained by combining first images PT1 and second images PT2, embodiments are not limited thereto. For example, composite images PC may be images obtained by combining first images PT1, second images PT2, third images PT3, and fourth images PT 4. In such a case, for example, the user U1 can see images with a viewing angle of 360 degrees. Accordingly, the user U1 can gain a sense of presence and a sense of immersion.

### [5. Processing by Communication Control Device]

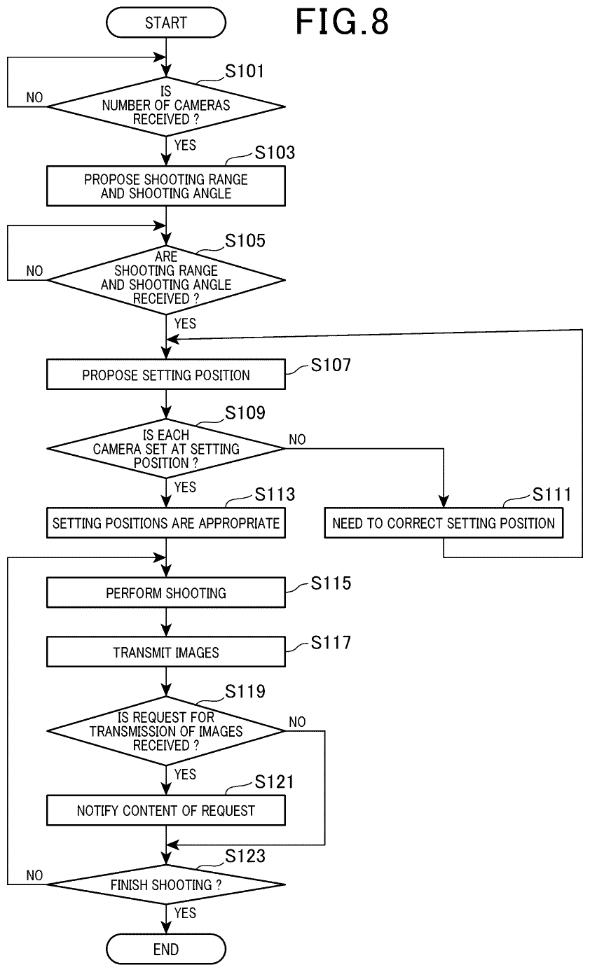

Next, processing by the communication control device 30 is described with reference to FIG. 8. FIG. 8 is a flowchart showing an example of the processing by the communication control device 30.

As shown in FIG. 8, in first in step S101, the reception unit 312 determines whether a first input operation QP1, which is an operation of inputting the number NC of cameras CM to be used for shooting, is received. The number NC of the cameras CM is, for example, “two”. The plurality of cameras CM includes, for example, the first camera 301 of the first smartphone 300A and the second camera 302 of the second smartphone 300B.

When the reception unit 312 determines that a first input operation QP1 is not received (step S101; NO), the processing falls in a wait state. When the reception unit 312 determines that a first input operation QP1 is received (step S101; YES), the processing moves to step S103.

In step S103, the proposal unit 313 proposes, to the touch panel 33, at least one of a shooting range AR and a shooting angle θ for each of the cameras CM. For example, the proposal unit 313 proposes the first shooting range AR1 and the first shooting angle θ1 for the first camera 301, and proposes the second shooting range AR2 and the second shooting angle θ2 for the second camera 302.

Next, in step S105, the reception unit 312 determines whether a second input operation QP2, which is an operation of inputting at least one of the shooting range AR and the shooting angle θ of each of the cameras CM, is received.

When the reception unit 312 determines that a second input operation QP2 is not received (step S105; NO), the processing falls in a wait state. When the reception unit 312 determines that a second input operation QP2 is received (step S105; YES), the processing moves to step S107.

In step S107, the proposal unit 313 proposes a setting position SP of each of the cameras CM. For example, the proposal unit 313 proposes the first setting position SA that is the setting position SP of the first camera 301, and proposes the second setting position SB that is the setting position SP of the second camera 302.

Next, in step S109, the determination unit 314 determines, based on images shot by each of the cameras CM, whether each of the cameras CM is set at the setting position SP thereof. For example, the determination unit 314 determines whether the first camera 301 is set at the first setting position SA. For example, the determination unit 314 determines whether the second camera 302 is set at the second setting position SB.

When the determination unit 314 determines that at least one of the cameras CM is not set at the setting position SP thereof (step S109; NO), the processing moves to step S111.

In step S111, the determination unit 314 determines that the setting position of the at least one of the cameras CM needs to be corrected. Thereafter, the processing returns to step S107.

When the determination unit 314 determines that each of the cameras CM is set at the setting position SP thereof (step S109; YES), the processing moves to step S113.

In step S113, the determination unit 314 determines that the setting position of each of the cameras CM is appropriate.

Next, in step S115, the transmission unit 311 causes each of the cameras CM to perform shooting. For example, the transmission unit 311 acquires first images PT1 shot by the first camera 301 of the first smartphone 300A, and second images PT2 shot by the second camera 302 of the second smartphone 300B.

Next, in step S117, the transmission unit 311 transmits, via the server device 100, the images PT shot by each of the cameras CM to the display devices 200 configured to be able to display the images PT. For example, the transmission unit 311 transmits the first images PT1 and the second images PT2 to the display devices 200 via the server device 100.

Next, in step S119, the reception unit 312 determines whether information indicating an operation RQ for requesting transmission of images PT shot by each of the cameras CM is received from a display device 200.

When the reception unit 312 determines that information indicating the operation RQ is not received (step S119; NO), the processing moves to step S123. When the reception unit 312 determines that information indicating the operation RQ is received (step S119; YES), the processing moves to step S121.

In step S121, the notification unit 317 notifies the content of the operation RQ to an occupant of the vehicle 3. For example, the notification unit 317 displays the content of the operation RQ on the touch panel 33.

Next, in step S123, the communication control device 30 determines whether to finish shooting by each of the cameras CM. For example, the communication control device 30 determines, based on an operation from the touch panel 33, whether to finish shooting by each of the cameras CM.

When the communication control device 30 determines not to finish shooting by each of the cameras CM (step S123; NO), the processing returns to step S115. When the communication control device 30 determines to finish shooting by each of the cameras CM (step S123; YES), then the processing is terminated.

Step S101 corresponds to an example of “reception step”.

Step S103 corresponds to an example of “proposal step”.

### [6. Configurations and Effects]

As described with reference to FIGS. 1 to 8 hereinabove, the communication control device 30 according to the present embodiment is a communication control device 30 that transmits, via the server device 100, images PT shot by the plurality of cameras CM mounted in the vehicle 3 to the display devices 200 configured to be able to display the images PT, and includes: the reception unit 312 that receives, from an occupant of the vehicle 3, a first input operation QP1 that is an operation of inputting the number NC of the cameras CM to be used for shooting; and the proposal unit 313 that proposes at least one of a shooting range AR and a shooting angle θ for each of the cameras CM, in response to the first input operation QP1.

With the configuration, at least one of a shooting range AR and a shooting angle θ is proposed for each of the cameras CM, in response to the first input operation QP1 that is an operation of inputting the number NC of the cameras CM to be used for shooting. Accordingly, the work of setting each of the cameras CM in the vehicle 3 can be performed based on at least one of the shooting range AR and the shooting angle θ. Accordingly, work efficiency in the work of setting the cameras CM in the vehicle 3 can be improved.

In the communication control device 30, the reception unit 312 receives, from the occupant of the vehicle 3, a second input operation QP2 that is an operation of inputting at least one of the shooting range AR and the shooting angle θ of each of the cameras CM, and the proposal unit 313 proposes a setting position SP of each of the cameras CM, in response to the second input operation QP2.

With the configuration, a setting position SP of each of the cameras CM is proposed in response to the second input operation QP2 that is an operation of inputting at least one of the shooting range AR and the shooting angle θ of each of the cameras CM. Accordingly, the work of setting each of the cameras CM in the vehicle 3 can be performed based on the proposed setting position SP of each of the cameras CM. Accordingly, work efficiency in the work of setting the cameras CM in the vehicle 3 can be improved.

The communication control device 30 includes the determination unit 314 that determines, based on the images PT shot by each of the cameras CM, whether each of the cameras CM is set at the setting position SP thereof.

With the configuration, it is determined, based on the images PT shot by each of the cameras CM, whether each of the cameras CM is set at the setting position SP thereof. Accordingly, it can be appropriately determined whether each of the cameras CM is set at the setting position SP thereof.

The communication control device 30 includes the option display unit 315 that causes a display device 200 to display options of images PT for the display device 200 to display, according to the number NC of the cameras CM.

With the configuration, the display device 200 is caused to display options of images PT for the display device 200 to display, according to the number NC of the cameras CM. Accordingly, convenience of a user U using the display device 200 can be improved.

In the communication control device 30, composite images PC obtained by combining a plurality of the images PT respectively shot by the cameras CM are generated, and a display device 200 is caused to display the composite images PC.

With the configuration, composite images PC obtained by combining a plurality of the images PT respectively shot by the cameras CM are generated, and a display device 200 is caused to display the composite images PC. Accordingly, for example, a sense of presence and a sense of immersion experienced by a user U using the display device 200 can be intensified, compared to a case where the images PT shot by one camera, of the images PT shot by the plurality of cameras, are displayed.

The communication control device 30 includes the transmission amount control unit 316 that, when a display device 200 continues to display only the images PT shot by one of the cameras CM for the threshold time period TH or longer, causes the server device 100 to reduce the amount of transmission, or stop transmission, of the images PT shot by the other of the cameras CM to the display device 200.

With the configuration, when a display device 200 continues to display only the images PT shot by one of the cameras CM for the threshold time period TH or longer, the server device 100 is caused to reduce the amount of transmission, or stop transmission, of the images PT shot by the other of the cameras CM to the display device 200. Accordingly, by appropriately setting the threshold time period TH, the amount of transmission of the images PT transmitted from the server device 100 to the display device 200 can be appropriately reduced.

The communication control device 30 includes the transmission amount control unit 316 that, when a display device 200 continues to display only the images PT shot by one of the cameras CM for the threshold time period TH or longer, reduces the amount of transmission, or stops transmission, of the images PT shot by the other of the cameras CM to the server device 100.

With the configuration, when a display device 200 continues to display only the images PT shot by one of the cameras CM for the threshold time period TH or longer, the amount of transmission of the images PT shot by the other of the cameras CM to the server device 100 is reduced, or such transmission is stopped. Accordingly, by appropriately setting the threshold time period TH, the amount of transmission of the images PT transmitted to the server device 100 can be appropriately reduced.

The communication control device 30 includes the notification unit 317 that, when an operation RQ for requesting transmission of the images PT shot by each of the cameras CM is received from a display device 200, notifies the content of the operation RQ to the occupant of the vehicle 3.

With the configuration, when an operation RQ for requesting transmission of the images PT shot by each of the cameras CM is received from a display device 200, the content of the operation RQ is notified to the occupant of the vehicle 3. Accordingly, for example, the occupant of the vehicle 3 can appropriately change the images PT shot by each of the cameras CM in response to the request from the display device 200.

In the communication control device 30, when an operation RQ for requesting transmission of the images PT shot by each of the cameras CM is received from a display device 200, the proposal unit 313 proposes at least one of a shooting range AR and a shooting angle θ for each of the cameras CM, according to the content of the operation RQ and the number NC of the cameras CM received by the reception unit 312.

With the configuration, when an operation RQ for requesting transmission of the images PT shot by each of the cameras CM is received, at least one of a shooting range AR and a shooting angle θ for each of the cameras CM is proposed according to the content of the operation RQ and the number NC of the cameras CM received. Accordingly, for example, the occupant of the vehicle 3 can appropriately and easily change the images PT shot by each of the cameras CM in response to the request from the display device 200.

The communication control method according to the present embodiment is a communication control method performed by the communication control device 30 that transmits, via the server device 100, images PT shot by the plurality of cameras CM mounted in the vehicle 3 to the display devices 200 configured to be able to display the images PT, and the communication control method includes: a reception step of receiving, from an occupant of the vehicle 3, an operation of inputting the number NC of the cameras CM to be used for shooting; and a proposal step of proposing at least one of a shooting range AR and a shooting angle θ for each of the cameras CM, in response to the number NC of the cameras CM.

Accordingly, the communication control method according to the present embodiment brings about operations and effects similar to those of the communication control device 30 according to the present embodiment.

The control program PG according to the present embodiment causes the processor 31 included in the communication control device 30 that transmits, via the server device 100, images PT shot by the plurality of cameras CM mounted in the vehicle 3 to the display devices 200 configured to be able to display the images PT, to function as: the reception unit 312 that receives, from an occupant of the vehicle 3, an operation of inputting the number NC of the cameras CM to be used for shooting; and the proposal unit 313 that proposes at least one of a shooting range AR and a shooting angle θ for each of the cameras CM, in response to the number NC of the cameras CM.

Accordingly, the control program PG according to the present embodiment brings about operations and effects similar to those of the communication control device 30 according to the present embodiment.

The communication control system 1 according to the present embodiment is the communication control system 1 including: the communication control device 30 that controls the plurality of cameras CM; and the server device 100 that receives images PT shot by the cameras CM from the communication control device 30 and transmits the images PT to the display device 200 configured to be able to display the images PT, wherein the communication control device 30 includes the reception unit 312 that receives, from an occupant of the vehicle 3, an operation of inputting the number NC of the cameras CM to be used for shooting, and the proposal unit 313 that proposes at least one of a shooting range A and a shooting angle θ for each of the cameras CM, in response to the number NC of the cameras CM.

Accordingly, the communication control system 1 according to the present embodiment brings about operations and effects similar to those of the communication control device 30 according to the present embodiment.

### [7. Other Embodiments]

The above-described embodiment is a preferred embodiment of the present invention. However, various modifications can be made to an extent that does not depart from the gist of the present invention, without being limited to the above-described embodiment.

For example, the embodiment describes a case where each of the “plurality of cameras” is disposed in a smartphone 300, embodiments are not limited thereto. Each of the “plurality of cameras” may be disposed in, for example, a tablet computer. Each of the “plurality of cameras” may be disposed in, for example, a notebook computer.

Each of the “plurality of cameras” may be a so-called digital camera. In such a case, it is preferable for the digital camera to include a communication function.

Although the present embodiment describes a case where the number NC of the cameras CM is two, embodiments are not limited thereto. The number NC of the cameras CM can be at least two. For example, the number NC of the cameras CM may be three or more.

Although the present embodiment describes a case where the proposal unit 313 proposes a shooting range AR and a shooting angle θ for each of the cameras CM in response to the first input operation QP1, embodiments are not limited thereto. The proposal unit 313 can propose at least one of a shooting range AR and a shooting angle θ for each of the cameras CM, in response to the first input operation QP1. For example, the proposal unit 313 may propose a shooting range AR for each of the cameras CM, in response to the first input operation QP1. For example, the proposal unit 313 may propose a shooting angle θ for each of the cameras CM, in response to the first input operation QP1.

The present embodiment describes a case where the communication control device 30 is configured by using an ECU, embodiments are not limited thereto. The communication control device 30 can include at least the processor 31, the memory 32, and the communication interface 34. The communication control device 30 may be configured by using, for example, a personal computer.

The communication control device 30 may be configured by using, for example, a smartphone.

In such a case, for example, the first smartphone 300A may include the transmission unit 311, the reception unit 312, the proposal unit 313, the determination unit 314, the option display unit 315, the transmission amount control unit 316, the notification unit 317, and the reference image storage unit 321.

For example, the second smartphone 300B may include the transmission unit 311, the reception unit 312, the proposal unit 313, the determination unit 314, the option display unit 315, the transmission amount control unit 316, the notification unit 317, and the reference image storage unit 321.

For example, another smartphone that differs from the first smartphone 300A or the second smartphone 300B may include the transmission unit 311, the reception unit 312, the proposal unit 313, the determination unit 314, the option display unit 315, the transmission amount control unit 316, the notification unit 317, and the reference image storage unit 321.

The communication control device 30 may be configured by using, for example, a plurality of smartphones. For example, the communication control device 30 may be configured by using two smartphones. In such a case, one smartphone may include one or some of the transmission unit 311, the reception unit 312, the proposal unit 313, the determination unit 314, the option display unit 315, the transmission amount control unit 316, the notification unit 317, and the reference image storage unit 321, and the other smartphone may include the remaining units of the transmission unit 311, the reception unit 312, the proposal unit 313, the determination unit 314, the option display unit 315, the transmission amount control unit 316, the notification unit 317, and the reference image storage unit 321.

Although the present embodiment describes a case where the communication control device 30 includes the touch panel 33, embodiments are not limited thereto. The communication control device 30 can include an input mechanism that receives operations performed by the sender S. The input mechanism may be, for example, a smartphone. The input mechanism may be, for example, a tablet computer.

The communication control device 30 shown in FIG. 2 is to illustrate the functional configuration thereof, and a specific form of implementation is not particularly limited. In other words, hardware pieces respectively corresponding to the individual functional units do not necessarily need to be mounted, and a configuration can also be made in which a single processor implements the functionality of the plurality of functional units by executing a program. One or some of the functions implemented by using software in the embodiment may be implemented by hardware, or one or some of the functions implemented by hardware may be implemented by using software.

Although the communication control device 30 includes the processor 31 and the memory 32 and the processor 31 functions as the various functional units by reading and executing the control program PG in the present embodiment, embodiments are not limited thereto.

The processor 31 may be configured by using a single processor, or by using a plurality of processors. The processor 31 may be hardware programmed in such a manner as to implement the corresponding functional units. In other words, such processors may be configured by using, for example, an application specific integrated circuit (ASIC) or a field programmable gate array (FPGA).

The units of processing in the flowchart shown in FIG. 8 are configured by division according to major processes, to facilitate understanding of the processing by the communication control device 30. The present invention is not limited by the way of division into, or the names of, the units of processing as illustrated in the flowchart of FIG. 8. The processing by the communication control device 30 can be divided into more units of processing, or can be divided in such a manner that one unit of processing includes more processes, depending on the content of processes. Moreover, order of the processes in the flowchart is not limited to the depicted example.

### [8. Configurations Supported by Embodiments]

The embodiments support the following configurations.

### Configuration 1

A communication control device that transmits, via a server device, images shot by a plurality of cameras mounted in a vehicle to a display device configured to be able to display the images, the communication control device including: a reception unit that receives, from an occupant of the vehicle, a first input operation that is an operation of inputting the number of the cameras to be used for shooting; and a proposal unit that proposes at least one of a shooting range and a shooting angle for each of the cameras, in response to the first input operation.

The communication control device according to configuration 1 proposes at least one of a shooting range and a shooting angle for each of the cameras, in response to the first input operation that is an operation of inputting the number of the cameras to be used for shooting. Accordingly, the work of setting each of the cameras in the vehicle can be performed based on at least one of the shooting range and the shooting angle. Accordingly, work efficiency in the work of setting the cameras in the vehicle can be improved.

### Configuration 2

The communication control device according to configuration 1, wherein the reception unit receives, from the occupant of the vehicle, a second input operation that is an operation of inputting at least one of the shooting range and the shooting angle of each of the cameras, and the proposal unit proposes a setting position of each of the cameras, in response to the second input operation.

The communication control device according to configuration 2 proposes a setting position of each of the cameras, in response to the second input operation that is an operation of inputting at least one of the shooting range and the shooting angle of each of the cameras. Accordingly, the work of setting each of the cameras in the vehicle can be performed based on the proposed setting position of each of the cameras. Accordingly, work efficiency in the work of setting the cameras in the vehicle can be improved.

### Configuration 3

The communication control device according to configuration 2, further including a determination unit that determines, based on the images shot by each of the cameras, whether each of the cameras is set at the setting position of the corresponding camera.

The communication control device according to configuration 3 determines, based on the images shot by each of the cameras, whether each of the cameras is set at the setting position thereof. Accordingly, it can be appropriately determined whether each of the cameras is set at the setting position thereof.

### Configuration 4

The communication control device according to any one of configurations 1 to 3, further including an option display unit that causes the display device to display options of the images for the display device to display, according to the number of the cameras.

The communication control device according to configuration 4 causes the display device to display options of the images for the display device to display, according to the number of the cameras. Accordingly, convenience of a user using the display device can be improved.

### Configuration 5

The communication control device according to any one of configurations 1 to 4, wherein composite images are generated, and the display device is caused to display the composite images, the composite images being obtained by combining a plurality of the images respectively shot by the cameras.

The communication control device according to configuration 5 generates composite images obtained by combining a plurality of the images respectively shot by the cameras, and causes the display device to display the composite images. Accordingly, for example, a sense of presence and a sense of immersion experienced by the user using the display device can be intensified, compared to a case where the images shot by one camera, of the images shot by the plurality of cameras, are displayed.

### Configuration 6

The communication control device according to any one of configurations 1 to 4, further including a transmission amount control unit that, when the display device continues to display the images shot by one of the cameras for a threshold time period or longer, causes the server device to reduce the amount of transmission, or stop transmission, of the images shot by the other or others of the cameras to the display device.

When the display device continues to display only the images shot by one of the cameras for the threshold time period or longer, the communication control device according to configuration 6 causes the server device to reduce the amount of transmission, or stop transmission, of the images shot by the other of the cameras to the display device. Accordingly, by appropriately setting the threshold time period, the amount of transmission of the images transmitted from the server device to the display device can be appropriately reduced.

### Configuration 7

The communication control device according to any one of configurations 1 to 4, further including a transmission amount control unit that, when the display device continues to display the images shot by one of the cameras for a threshold time period or longer, reduces the amount of transmission, or stops transmission, of the images shot by the other or others of the cameras to the server device.

When the display device continues to display only the images shot by one of the cameras for the threshold time period or longer, the communication control device according to configuration 7 reduces the amount of transmission, or stops transmission, of the images shot by the other of the cameras to the server device. Accordingly, by appropriately setting the threshold time period, the amount of transmission of the images transmitted to the server device can be appropriately reduced.

### Configuration 8

The communication control device according to any one of configurations 1 to 6, further including a notification unit that, when an operation for requesting transmission of the images shot by each of the cameras is received from the display device, notifies content of the operation to the occupant of the vehicle.

When an operation for requesting transmission of the images shot by each of the cameras is received from the display device, the communication control device according to configuration 8 notifies the content of the operation to the occupant of the vehicle. Accordingly, for example, the occupant of the vehicle can appropriately change the images shot by each of the cameras, in response to the request from the display device.

### Configuration 9

The communication control device according to any one of configurations 1 to 8, wherein when an operation for requesting transmission of the images shot by each of the cameras is received from the display device, the proposal unit proposes at least one of a shooting range and a shooting angle for each of the cameras, according to content of the operation and the number of the cameras received by the reception unit.

When an operation for requesting transmission of the images shot by each of the cameras is received, the communication control device according to configuration 9 proposes at least one of a shooting range and a shooting angle for each of the cameras, according to the content of the operation and the number of the cameras received. Accordingly, for example, the occupant of the vehicle can appropriately and easily change the images shot by each of the cameras, in response to the request from the display device.

### Configuration 10

A communication control method performed by a communication control device that transmits, via a server device, images shot by a plurality of cameras mounted in a vehicle to a display device configured to be able to display the images, the communication control method including: a reception step of receiving, from an occupant of the vehicle, an operation of inputting the number of the cameras to be used for shooting; and a proposal step of proposing at least one of a shooting range and a shooting angle for each of the cameras, in response to the number of the cameras.

The communication control method according to configuration 10 can obtain the same effects as those of the communication control device according to configuration 1.

### Configuration 11

A non-transitory computer readable storage medium storing a control program causing a processor included in a communication control device that transmits, via a server device, images shot by a plurality of cameras mounted in a vehicle to a display device configured to be able to display the images, to function as: a reception unit that receives, from an occupant of the vehicle, an operation of inputting the number of the cameras to be used for shooting; and a proposal unit that proposes at least one of a shooting range and a shooting angle for each of the cameras, in response to the number of the cameras.

The storage medium according to configuration 11 can obtain the same effects as those of the communication control device according to configuration 1.

### Configuration 12

A communication control system including: a communication control device that controls a plurality of cameras; and a server device that receives images shot by the cameras from the communication control device and transmits the images to a display device configured to able to display the images, wherein the communication control device includes a reception unit that receives, from an occupant of a vehicle, an operation of inputting the number of the cameras to be used for shooting, and a proposal unit that proposes at least one of a shooting range and a shooting angle for each of the cameras, in response to the number of the cameras.

The communication control system according to configuration 12 can obtain the same effects as those of the communication control device according to configuration 1.

### REFERENCE SIGNS LIST

1 communication system, 3 vehicle, 13 headrest stay, 30 communication control device, 31 processor, 311 transmission unit, 312 reception unit, 313 proposal unit, 314 determination unit, 315 option display unit, 316 transmission amount control unit, 317 notification unit, 32 memory, 321 reference image storage unit, 33 touch panel, 34 communication interface, 50 attachment, 51 first fastener, 100 server device, 200 display device, 200A first display device, 200B second display device, 200C third display device, 300 smartphone, 300A first smartphone, 300B second smartphone, 301 first camera, 302 second camera, AN1 first response, AN2 second response, AR shooting range, BP composite image button, CH to-be-displayed image selection part, CM camera, MV VR mode display part, NC number of cameras, PG control program, PN reference image, PT image, PT1 first image, PT2 second image, PTA front image, PTB right image, driver image, PTC rear image, PTD left image, QP1 first input operation, QP2 second input operation, RQ operation, S sender (vehicle occupant), SA first setting position, SB second setting position, SP setting position, TH threshold time period, TP touch panel, U, U1-U3 user, VS field of view, θ shooting angle

1. A communication control device that transmits, via a server device, images shot by a plurality of cameras mounted in a vehicle to a display device configured to be able to display the images, the communication control device comprising:
a reception unit that receives, from an occupant of the vehicle, a first input operation that is an operation of inputting the number of the cameras to be used for shooting; and
a proposal unit that proposes at least one of a shooting range and a shooting angle for each of the cameras, in response to the first input operation.

2. The communication control device according to claim 1, wherein
the reception unit receives, from the occupant of the vehicle, a second input operation that is an operation of inputting at least one of the shooting range and the shooting angle of each of the cameras, and
the proposal unit proposes a setting position of each of the cameras, in response to the second input operation.

3. The communication control device according to claim 2, further comprising a determination unit that determines, based on the images shot by each of the cameras, whether each of the cameras is set at the setting position of the corresponding camera.

4. The communication control device according to claim 1, further comprising an option display unit that causes the display device to display options of the images for the display device to display, according to the number of the cameras.

5. The communication control device according to claim 1, wherein composite images are generated, and the display device is caused to display the composite images, the composite images being obtained by combining a plurality of the images respectively shot by the cameras.

6. The communication control device according to claim 1, further comprising a transmission amount control unit that, when the display device continues to display the images shot by one of the cameras for a threshold time period or longer, causes the server device to reduce the amount of transmission, or stop transmission, of the images shot by the other or others of the cameras to the display device.

7. The communication control device according to claim 1, further comprising a transmission amount control unit that, when the display device continues to display the images shot by one of the cameras for a threshold time period or longer, reduces the amount of transmission, or stops transmission, of the images shot by the other or others of the cameras to the server device.

8. The communication control device according to claim 1, further comprising a notification unit that, when an operation for requesting transmission of the images shot by each of the cameras is received from the display device, notifies content of the operation to the occupant of the vehicle.

9. The communication control device according to claim 1, wherein when an operation for requesting transmission of the images shot by each of the cameras is received from the display device, the proposal unit proposes at least one of a shooting range and a shooting angle for each of the cameras, according to content of the operation and the number of the cameras received by the reception unit.

10. A communication control method performed by a communication control device that transmits, via a server device, images shot by a plurality of cameras mounted in a vehicle to a display device configured to be able to display the images, the communication control method comprising:
a reception step of receiving, from an occupant of the vehicle, an operation of inputting the number of the cameras to be used for shooting; and
a proposal step of proposing at least one of a shooting range and a shooting angle for each of the cameras, in response to the number of the cameras.

11. A non-transitory computer readable storage medium storing a control program causing a processor included in a communication control device that transmits, via a server device, images shot by a plurality of cameras mounted in a vehicle to a display device configured to be able to display the images, to function as:
a reception unit that receives, from an occupant of the vehicle, an operation of inputting the number of the cameras to be used for shooting; and
a proposal unit that proposes at least one of a shooting range and a shooting angle for each of the cameras, in response to the number of the cameras.

12. A communication control system comprising:
a communication control device that controls a plurality of cameras mounted in a vehicle; and
a server device that receives images shot by the cameras from the communication control device and transmits the images to a display device configured to able to display the images,
wherein the communication control device includes
a reception unit that receives, from an occupant of the vehicle, an operation of inputting the number of the cameras to be used for shooting, and
a proposal unit that proposes at least one of a shooting range and a shooting angle for each of the cameras, in response to the number of the cameras.
